(19) United States
(12) Patent Application Publication
(10) Pub. No.: US 2011/0013390 A1
(43) Pub. Date: Jan. 20, 2011

(54) Illuminated Tile

(75) Inventors: Alexander Biebel, Bickenbach (DE); Thomas Meisel, Bermatingen/Baden (DE)

Correspondence Address: CONNOLLY BOVE LODGE & HUTZ, LLP, P O BOX 2207, WILMINGTON, DE, 19899, US

(73) Assignee: Merck Patent GmbH Patents & Scientific Information, Darmstadt (DE)

(21) Appl. No.: 12/295,472

(22) PCT Filed: Mar. 20, 2007
(86) PCT No.: PCT/EP07/02436

§ 371 Date: Aug. 25, 2010

(30) Foreign Application Priority Data
Mar. 31, 2006 (DE) 10 2006 015 437.1

(51) Int. Cl. F21V 11/00; F21S 4/00

(52) U.S. Cl. 362/235; 362/249.02

(57) ABSTRACT

The present invention relates to a light-emitting tile having a layer structure which includes a visible plate (2) and at least one illuminant, which is characterised in that the illuminant provided is at least one OLED (3).

The present invention relates to a light-emitting tile in accordance with the preamble of Patent Claim 1. Illuminated tiles of this type are already known for the design of wail and floor coverings in buildings, in particular baths. Illuminated tiles of this type are described, for example, in DE 20 2004 006 389 U1 and DE 10 2005 002 783 A1.

The illuminants disclosed in these documents are LEDs. Even in the flat design, however, these have a certain physical height, which makes integration into a wall or floor tile more difficult. In addition, flat illumination is only possible using a plurality of LEDs with corresponding constructional complexity with respect to the arrangement and electrical connection. LEDs basically tend to be more suitable as point emitters and not for flat illumination.

DE 20 2004 007 881 U1 likewise discloses a light-emitting tile which has electroluminescent pigments as illuminants. However, this type of illuminant has some disadvantages. Firstly, the lifetime is much too short for a tile to be installed in a building. In addition, the luminosity of this illuminant is very low and furthermore is not constant. Finally, an illuminant based on electrical luminescence requires a comparatively high voltage supply, which prevents, in particular, use in a moist environment and overall makes handling more difficult due to safety measures that are correspondingly necessary.

The object of the present invention was therefore to provide a light-emitting tile in which the disadvantages described above are avoided and greater design freedom with respect to the type of illumination is possible.

This object is achieved by a light-emitting tile in accordance with the preamble of Patent Claim 1 through the characterising features thereof.

The measures indicated in the sub-claims make advantageous embodiments and refinements of the invention possible.

Accordingly, a light-emitting tile according to the invention is distinguished by the fact that the illuminant provided is at least one OLED.

Organic LEDs (so-called OLEDs) are distinguished by the fact that, on the one hand, they can easily be applied uniformly in a two-dimensional manner, but also in structures. They can be applied, for example, in liquid form in print patterns using a colour printer, in particular an ink-jet printer.

The use of one or more OLEDs thus facilitates great design freedom in the structure of the illuminant.

In a simple variant, continuously flat illumination can be achieved by a correspondingly two-dimensional distribution of the illuminant. However, it is also readily possible, for example for design reasons, to achieve a certain graphic design with the illuminant.

The light-emitting tile is preferably built up in a layer structure with at least one transparent plate and one or more OLEDs. In addition, an interspace for the at least one OLED may be provided between the visible plate and a support plate on the back. The interspace here is preferably sealed so that the OLED is protected against interfering influences from the environment, for example against soiling, against atmospheric oxygen or the like.

In a preferred refinement of the invention, the electrical connections of the illuminant are provided on the back of the light-emitting tile. In this way, contacting which is not visible from the viewer side can take place, so that a light-emitting tile can be inserted seamlessly and without interfering connections into the join pattern together with other tiles.

The connections here can encompass, for example, a snap-in contact, i.e. in such a case contact elements which lock with a matching counter-piece during laying of the light-emitting tile are installed in the substrate.

In another embodiment, a spring contact is provided which makes the electrical contact with a counter-contact when the light-emitting tile is pressed against the substrate.

As already mentioned above, the electrical connection is advantageously pre-installed in the building during construction before installation of the light-emitting tile, so that the electrical connection can be made easily, for example by snap-fit or by spring pressure, during laying of the tile.

In a refinement of the invention, two or more OLEDs are provided. OLEDs of this type can be designed in the same colour or different colours. This gives rise to further possibilities in the design of the illumination. Thus, for example, a pictorial design or a time sequence of different OLEDs of the same colour or different colours can take place and varying illumination can thus also be caused.

To this end, a plurality of contacts are preferably pre-installed during construction in order to be able to address the individual OLEDs separately.

In a refinement of this embodiment, a matrix of OLED pixels and corresponding contact elements is provided, so that an OLED display or an OLED monitor can be achieved in a light-emitting tile of this type.

In order to achieve a display or monitor, it is also possible for an additional LCD to be installed before an OLED layer. The OLED layer here can be used simply as flat illuminant, since the desired structures are caused by addressing the LCD.

Besides the structuring by corresponding distribution of one or more OLEDs, it is of course also possible to provide a cover layer. A cover layer of this type may include, for example, inscriptions, graphical representations or the like, which then serve to design the illumination of the light-emitting tile on use of an OLED as illuminant.

In addition, at least one optical filter layer is preferably provided in order, for example, to influence the colour of the illuminant and/or to offer additional protection against soiling.

In a particularly preferred embodiment of the invention, electronic components, for example resistors, capacitors or active control elements, are additionally integrated into the light-emitting tile. These components can be accommodated, for example, in a layer installed behind the OLED. However, the light-emitting tile may also be designed in such a way that the illuminant does not take up the entire area, but instead a region, for example an edge region, is available for the accommodation of electronic components of this type.

In another embodiment, electronic components with the contact elements as integrated assembly are provided. The control elements here can be provided in the tile and/or in the building.

Another simple way of accommodating electronic components of this type consists, for example, in making the recess for leading-through the electronic contact on the back, i.e. on the support plate, so large that there is additionally space for the said components in addition to the line to be leaded-through.

An illustrative embodiment of the invention is shown in the drawing and is explained in greater detail below with reference to the figures, in which, in detail,

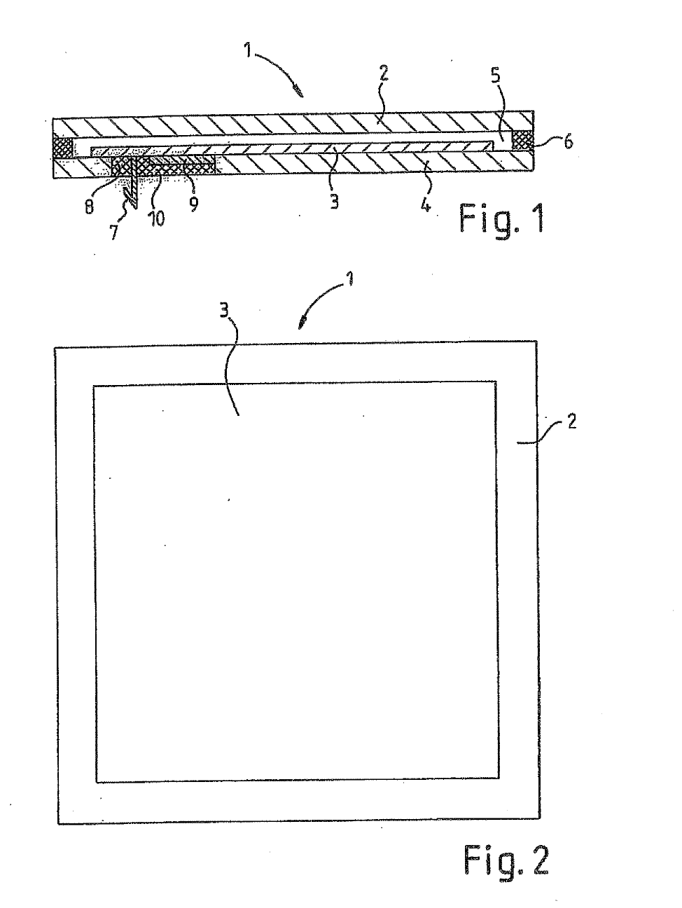

FIG. 1 shows a diagrammatic sectional representation through a light-emitting tile according to the invention and

FIG. 2 shows a plan view of a light-emitting tile according to the invention.

The light-emitting tile 1 in accordance with FIG. 1 is built up in layers from an at least partially transparent visible plate 2, an OLED layer 3 and a support plate 4 on the back. In principle, further interlayers, for example filter layers, may also be provided.

The interspace 5 between the visible plate 2 and the support plate 4 is sealed by seals 6 at the edges, which simultaneously serve as spacers.

The electrical contacting of the light-emitting tile 1 takes place on the back, with a hook-shaped snap-in contact 7 being shown by way of example in FIG. 1. The snap-in contact 7 is connected to an electrode, not shown in greater detail, of the OLED layer 3 and is capable of locking with a counterpiece installed in the building during construction, so that an electrical contact is made at the same time as installation of the light-emitting tile 1. Further contacts, for example further snap-in contacts 7, which may be in a line with the snap-in contact 7 shown and are thus not visible in FIG. 1, may be provided for addressing the OLED layer 3.

The passage 8 through the support plate 4 is kept sufficiently large that there is space for additional components, for example electronic control elements 9. In addition, the passage 8 is sealed in a liquid- and gas-tight manner using a sealant 10, for example silicone.

FIG. 2 shows a plan view of the light-emitting tile 1. In this simple variant, the illuminant, i.e. the OLED layer 3, is applied as a rectangle, giving rise to simple flat illumination. As already stated above, however, it is readily possible, if an OLED layer is used, for the latter to be patterned or provided with a graphic design in another manner. The use of a plurality of OLED elements, which are likewise provided with a graphic design under certain circumstances, is also possible. The use of a corresponding control enables one or more OLEDs of the same colour or different colours to be addressed simultaneously or in a certain time sequence.

It is also readily conceivable to design a display with a corresponding number of pixels and contact elements.

The precise design of an OLED layer 3 can thus be carried out in a wide variety of ways. Essential for the invention, however, is the large variation latitude of the design possibilities which arise through the use of one or more OLEDs as illuminants for a light-emitting tile.

### List of Reference Symbols

1 Light-emitting tile
2 Visible plate
3 OLED layer
4 Support plate
5 Interspace
6 Seal
7 Snap-in contact
8 Passage
9 Control element
10 Sealant

1.-12. (canceled)

13. A light-emitting tile comprising a layer structure including a transparent plate and at least one illuminant, wherein the illuminant comprises an OLED.

14. The light emitting tile of claim 1, a backside of the layer structure further including a support plate, wherein the at least one OLED is disposed within a sealed interspace formed between the transparent plate and the support plate.

15. The light emitting tile of claim 1, wherein a backside of the layer structure includes an electrical contact for the illuminant.

16. The light emitting tile of claim 1, wherein the electrical contact comprises at least one of a snap-in contact and a spring contact.

17. The light emitting tile of claim 1, wherein the electrical contact comprises a counter-contact.

18. The light emitting tile of claim 1, wherein the illuminant comprises two or more OLEDs.

19. The light emitting tile of claim 18, the layer structure further including at least one electrical contact for each OLED.

20. The light emitting tile of claim 1, wherein the transparent plate includes at least one of an inscription, a print image, and an LCD.

21. The light emitting tile of claim 1, the layer structure further including an optical filter layer.

22. The light emitting tile of claim 1, the layer structure further including one or more integrated electronic components.

23. The light emitting tile of claim 22, wherein at least one of the electronic components is integrated into an electrical contact element on a backside of the layer structure.

24. The light emitting tile of claim 1, wherein electronic components are disposed in a recess for leading-through the electrical contact on the backside of the layer structure.
